(19) United States
(12) Patent Application Publication
(10) Pub. No.: US 2010/0097206 A1
(43) Pub. Date: Apr. 22, 2010

(54) Post Cap for Guardrail with Luminous Lamp

(75) Inventors: Changho Jung, Busan (KR); Wonjeong Jeong, Suwon-si (KR)

Correspondence Address: Hyun Jong Park;Park & Associates Intellectual Property Law LLC, Suite 106, 265 Bic Drive, Milford, CT, 06461, US

(73) Assignee: SAMCHANG S.C CO., LTD., Busan (KR)

(21) Appl. No.: 12/642,335

(22) Filed: Dec. 18, 2009

Related U.S. Application Data
(63) Continuation of application No. PCT/KR2008/003398, filed on Jun. 17, 2008.

(30) Foreign Application Priority Data
Jun. 21, 2007 (KR) 10-2007-0060966

(51) Int. Cl. G08B 1/08; F21V 9/00; G01S 19/14; E01F 15/00; G06K 7/01

(52) U.S. Cl. 340/539.1; 362/231; 342/357.09; 256/1; 340/10.51

(57) ABSTRACT

The present invention relates to a post cap for a guardrail equipped with light emission means. The post cap for a guardrail is configured to produce beautiful scenery through variation in the color and the blinking state and to ensure safe nighttime passage through the transmission of signals depending on situations. The post cap for a guardrail equipped with light emission means capable of emitting light of various colors is configured to detect the location of installation and time through the reception of GPS signals and to enable a plurality of post caps to implement variations in color in conjunction with each other through time-based variations in color according to a stored program based on the location of installation.

### REFERENCE TO RELATED APPLICATIONS

This is a continuation of pending International Patent Application PCT/KR2008/003398 filed on Jun. 17, 2008, which designates the United States and claims priority of Korean Patent Application No. 10-2007-0060966 filed on Jun. 21, 2007, the entire contents of which are incorporated herein by reference.

### FIELD OF THE INVENTION

The present invention relates, in general, to a post cap for a guardrail equipped with light emission means, and, more particularly, to a post cap for a guardrail equipped with light emission means that receives Global Positioning System (GPS) signals, detects the location of installation thereof, and emits light of various colors according to a previously stored program based on the location and time, thereby enabling a plurality of post caps to vary the colors thereof in conjunction with each other.

### BACKGROUND OF THE INVENTION

A typical guardrail is a means that is installed to prevent the falling of vehicles that pass over a bridge. However, the guardrail has poor noticeability during nighttime or in bad weather, and thus the case in which the driver of a vehicle does not become aware of the guardrail and posts and comes into collision therewith or falls off the bridge frequently occurs.

In order to provide safety measures, various schemes for increasing the noticeability of a guardrail have been proposed. One of them is Korean Utility Model Registration No. 20-1992-22060 entitled ‘Post Cap for Guardrail equipped with Illumination Device.’

However, the preceding technology is inconvenient in that, in the case where power supply wiring connected to a lamp needs to be repaired because a failure occurs therein or an electric bulb needs to be replaced with a new one, not only a cap at the upper end of a post but also the entire post must be removed from a guardrail.

Furthermore, it has many problems, for example, in that it is ordinarily vulnerable to dangers, such as electric leakage, because, in bad weather, water permeates into the power supply wiring laid under the ground below the post and connected to the lamp.

In order to overcome the above problems, Korean Utility Model Registration No. 400233 filed by the present applicant, issued to the present applicant and entitled “Post Cap for Guardrail equipped with Light Emission Lamp” proposes a post cap in which one or more solar cells are provided inside the post cap, the post cap is charged using solar light, and then light emission is performed. The post cap for a guardrail equipped with a light emission lamp is configured such that the post cap 30 is installed at the top of the post 10 of a guardrail 20, as shown in FIG. 1, and thus it is charged using solar light during the daytime and emits light during the nighttime.

The structure of the post cap for a guardrail, as shown in FIG. 2, includes a lower cap 100, one or more solar cells 200 and an upper cap 300, thus resulting in a post cap 30. The solar cells 200 are detachably attached inside the lower cap 100, and then the upper cap 300 is engaged with the lower cap 100 in a threaded manner.

However, the above-described post cap for a guardrail has problems in that it simply operates in a form in which it is turned on during the nighttime and turned off during the daytime as set at the time of manufacture thereof because it is difficult to control the blinking state thereof, and in that it cannot operate in consideration of variations in the surroundings nor in conjunction with adjacent post caps for a guardrail.

### SUMMARY OF THE INVENTION

Accordingly, the present invention has been made keeping in mind the above problems occurring in the prior art, and an object of the present invention is to provide a post cap for a guardrail equipped with light emission means that can check the location of installation thereof and then emit light in conjunction with adjacent post caps, thereby producing beautiful scenery, and that enables light emission signals to be easily changed from the outside.

Another object of the present invention is to provide a post cap for a guardrail equipped with light emission means that can detect a surrounding situation and then emit light based on the detected situation, thereby rapidly providing guidance.

In order to accomplish the above objects, the present invention provides a post cap for a guardrail equipped with light emission means capable of emitting light of various colors, including a Global Positioning System (GPS) reception unit for receiving GPS signals from satellites; a storage unit for storing a program capable of controlling the light emission means based on a location of installation and time; and a control unit for detecting the location of installation and time based on the GPS signals and the time input through the GPS reception unit, and controlling blink of the light emission means and color according to the program stored in the storage unit; wherein the GPS signals are received, the location of installation and the time are detected based on the GPS signals, and variation in color is achieved based on the location of installation and the time according to the stored program, thereby enabling a plurality of adjacent post caps to operate with each other so as to emit light.

According to a preferred embodiment, the post cap further includes a Radio Frequency (RF) reception unit for receiving Radio Frequency Identification (RFID) signals, and thus settings of the program stored in the storage unit can be changed in such a way that a manager brings an RFID chip, in which settings of the program are stored, into contact with the RF reception unit.

According to a preferred embodiment, the post cap is connected to the adjacent post caps via a Ubiquitous Sensor Network (USN), monitors a surrounding situation, and enables a color and blinking state of the light emission means to be controlled in response to detection signals.

According to a preferred embodiment, a manager wirelessly sends settings of the program via the USN and then changes current settings of the program stored in the storage unit.

According to a preferred embodiment, the light emission means is provided with red, green and blue Light Emitting Diodes (LEDs), and represents various colors and patterns through combination of the LEDs.

The above-described post cap for a guardrail equipped with light emission means has an advantage in that the post cap receives GPS signals, checks the location of installation and the time, and emits light based on the location and the time according to a previously stored program, thereby producing beautiful scenery in conjunction with adjacent post caps.

Furthermore, the post cap for a guardrail equipped with light emission means has another advantage in that the settings of a program stored in the post cap can be changed using Radio Frequency Identification (RFID) or a Ubiquitous Sensor Network (USN), thereby enabling easy manipulation.

Moreover, the post cap for a guardrail equipped with light emission means has another advantage in that the post cap is connected to a plurality of adjacent post caps via a USN, so that the adjacent post caps can receive information about a situation detected by the post cap and the post cap can represent light signals in conjunction with the adjacent post caps, thereby rapidly providing guidance to drivers who are passing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a guardrail equipped with guardrails;

FIG. 2 is an exploded perspective view showing a post cap for a guardrail; and

FIG. 3 is a diagram showing the construction of a post cap for a guardrail equipped with light emission means according to an embodiment of the present invention.

### DETAILED DESCRIPTION OF THE INVENTION

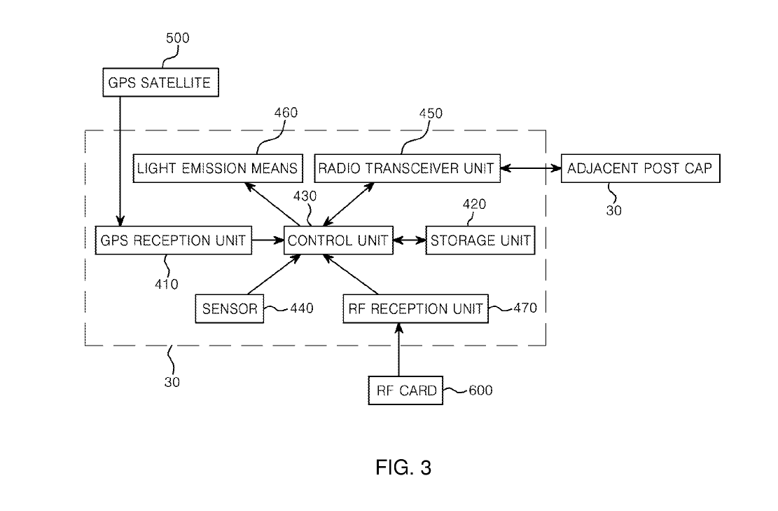

A post cap for a guardrail equipped with light emission means according to an embodiment of the present invention will be described in detail below with reference to the accompanying drawings. FIG. 3 is a diagram showing the internal construction of a post cap for a guardrail equipped with light emission means according to an embodiment of the present invention.

The post cap for a guardrail equipped with light emission means according to the present invention may be basically divided into a post cap 30, light emission means 460, a GPS reception unit 410, a storage unit 420 and a control unit 430.

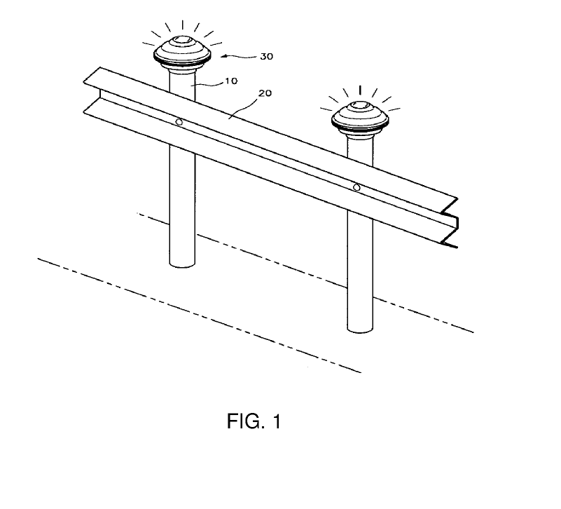

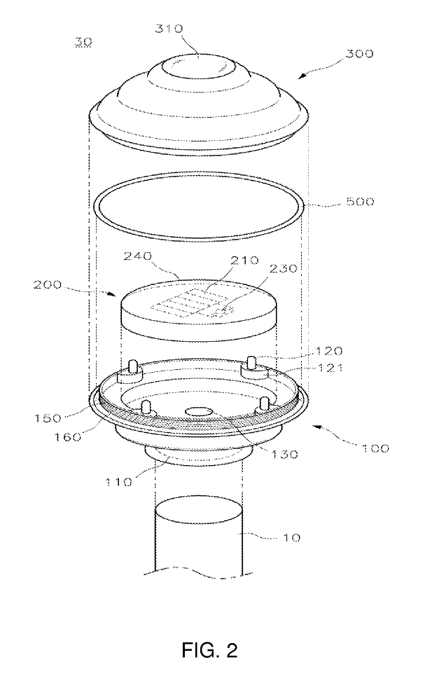

The post cap 30 will be described below first. The post cap 30 is attached at the top of the post 10 of a guardrail 20, as shown in FIG. 1. The post cap 30 is formed in a structure that can be separated into upper and lower parts in the embodiment of the present invention, as shown in FIG. 2, and is made of transparent or translucent material, and thus light from the light emission means, which will be described later, can be viewed from the outside thereof.

However, the post cap 30 of the present invention is not intended to be limited to the above-described configuration. The post cap 30 may be combined with the post, and may be constructed in various configurations as long as the light emission means 460, the GPS reception unit 410, the storage unit 420 and the control unit 430, which will be described later, can be installed therein.

One or more solar cells capable of generating electricity are provided inside the post cap 30, and a convex lens is disposed in the upper side of the post cap 30 to transmit a larger amount of solar light to the solar cell. However, it is possible to connect electrical wire to a post cap or use wind power or other power sources instead of using such solar cells.

Next, the light emission means 460 will be described. The light emission means 460 includes one or more electrical bulbs or one or more Light Emitting Diodes (LEDs), and emits light when power is supplied thereto. The light emission means 460 includes electric bulbs or LEDs having various colors so that various colors may be represented, and thus the light emission means 460 may represent various colors by combining the colors.

In an embodiment of the present invention, blue B, green G and red R color LEDs are provided as the light emission means 460, and desired colors are represented through the combination of the light emission means 460.

Here, the light emission means 460 is not limited to a simple device for emitting various rays of light. A construction in which a character or one of various patterns can be represented through the combination of a plurality of LEDs may be worth consideration. In this case, the light emission means may be exposed to the outside, rather than being installed inside the post cap 30, so that the character or pattern is visible from the outside.

Next, the GPS reception unit 410 will be described below. The GPS reception unit 410 receives location and time signals from a plurality of satellites 500.

Since the reception of signals from the GPS satellites 500 is well known to those skilled in the art, a detailed description thereof will be omitted here.

Next, the storage unit 420 will be described below. The storage unit 420 stores settings for the manipulation of the light emission means 460 based on the installation location of the post cap for a guardrail and the current time.

The information stored in the storage unit 420 includes the coordinates of a road where the post cap for a guardrail will be installed, and the state information of respective points. That is, various road conditions related to whether a road at a specific location is an inclined road, a curved road, or a road in a frequent accident area, in a falling stone area or on a cliff, and information related to the number of lanes of the road, are stored therein, and light emission information for a road under specific conditions is stored therein as well.

For example, settings for the emission of a bright warning light for a curved road, an inclined road or a stone falling area, settings for the blink of the light emission means 460 so that vehicles can notice the blinking and travel carefully, or settings for the representation of blue color or green color for a rectilinear road are stored therein.

The reason why settings are stored in the storage unit 420 as described above is to generate appropriate colors or blinking signals, even if the same type of post caps for a guardrail are installed.

As a result, there can be avoided problems in which, in the case where differently set post caps 30 are installed at respective locations at the time of installing the post caps for a guardrail, the settings of the post caps 30 must be checked and then installed, and a plurality of post caps 30 must be carried to a site and excessive inventory must be maintained because different post caps 30 must be provided in order to perform rapid replacement at the time of damage or failure.

Next, the control unit 430 will be described below. The control unit 430 generates control signals for the control of the light emission means 460 according to a program stored in the storage unit 420. For this purpose, the control unit 430 checks the installation location of each post cap for a guardrail and the time by analyzing signals received from the satellites 500 via the GPS reception unit 410, searches the settings of the storage unit using the location and the time information, and generates control signals for the control of the light emission means 460.

Furthermore, a construction in which, when the RF reception unit 470 is connected and a card 600 in which an RF chip is embedded is brought into contact with the RF reception unit 470 from the outside, the control unit 430 receives signals from the card 600 in which the RF chip is embedded and controls the light emission means 460 in response to the signals, instead of controlling the light emission means 460 based on location and time, may be worth consideration.

For example, in the case where it is necessary to block a road due to flooding, a heavy snowfall, an earthquake, falling stones or a traffic accident, when a manager carries the card 600 equipped with an RF chip that stores information about the blocking of a road and a blocked area and brings the card 600 into contact with the RF reception unit 470 of the post cap for a guardrail, post caps for a guardrail in an area adjacent to the blocked area emit red warning light and post caps for a guardrail in an area outside the adjacent area emit yellow warning light, with the result that vehicles can travel while avoiding an area in which a road is blocked by checking the type of warning light.

A construction in which the post cap 30 is provided with a sensor 440, a connection is established via a USN capable of sending signals, detected by the sensor 440, to adjacent post caps 30 or a manager to exchange information, and the control unit 430 receives the information and controls the light emission means 460 may be worth consideration.

For example, when a sensor 440 capable of detecting temperature or smoke is provided on one side of or outside the post cap 30 and the sensor 440, in case of a fire, detects the fire and transmits a fire occurrence signal to adjacent post caps 30, they, i.e., the post caps 30 adjacent to the post cap 30 which has detected the fire, emit warning light.

A construction in which the distances from the site of a fire are calculated and light having different colors is generated depending on the distances may be worth consideration. That is, vehicles can safely deal with situations in such a way that post caps 30 near the site of a fire emit red warning light, post caps 30 in an area somewhat away from the site emit yellow warning light, and post caps 30 in an area safely removed from the fire operate normally.

A construction in which a sensor 440 capable of detecting ice formation on a road or the occurrence of falling stones, instead of detecting a fire as described above, is provided, and transmits information to other post caps 30, thereby controlling light emitting signals, may be worth consideration.

Furthermore, in the case of the USN, communication between the post caps 30 can not only be performed, but a manager can also transmit information to the post caps 30, with the result that the light emission means 460 can be controlled, even if the sensor 440 does not perform detection.

Here, a construction in which a plurality of LEDs is combined with a plate to represent a character or a pattern, so that the post cap can be used as a nighttime illumination device during normal times and can indicate an emergency situation in the form of the character or pattern (for example, an arrow or a falling stone image) in the case of an emergency, thereby enabling the drivers of vehicles to easily learn of it, rather than the construction in which the light emission means 460 is configured to simply change color, may be worth consideration.

The operation and effects of each post cap for a guardrail equipped with light emission means according to an embodiment of the present invention will be described in detail below with reference to the accompanying drawings. A convex lens is disposed in the upper portion of the post cap 30 of the present invention, and is provided with one or more solar cells and a battery therein. The reason for this is to generate and store electricity using solar light and emit light without using a separate power source.

A GPS reception unit 410, including an antenna configured to receive GPS signals and a line connected from the antenna to the control unit 430, is installed in one side of the post cap 30. The map information of an area of installation, light emission patterns based on the conditions of a road, and light emission patterns for special situations are stored in a storage unit 420 formed of fresh RAM.

Furthermore, the post cap 30 is provided with a radio transceiver unit 450 for participation in a USN, and thus the post cap 30 can exchange information with adjacent post caps 30.

Thereafter, post caps 30 are transported to an installation site, and are installed at respective tops of the posts of a guardrail. Moreover, a sensor 440 for detecting a fire and a sensor 440 for detecting an impact when the impact is applied to the guardrail are connected to each of the post caps 30.

After power is supplied by the solar cells and the battery after installation, each post cap 30 receives GPS signals, searches for a location at which the post cap 30 is installed, and checks road information at the location in the storage unit 420.

In this case, a construction in which signals are received from a mobile phone base station and a location is detected based on the signals, rather than a construction in which the GPS reception unit 410 receives GPS signals, may be worth consideration.

When the road under consideration is indicated as a curved road in the road information stored in the storage unit 420, a post cap 30 under consideration, as well as adjacent post caps 30, sequentially blink from one end to the other end during nighttime, thereby enabling the drivers of vehicles to learn of the curved road.

When an accident occurs on the curved road, and thus an impact is applied to one side of a guardrail, the accident is detected and information about the occurrence of the accident and location information are sent to an adjacent cap post 30 using the radio transceiver unit 450.

The adjacent post cap 30 having received the information sends the received signals to another adjacent post cap 30, calculates the distance between the location of the occurrence of the accident and the location thereof, and turns on a red lamp to allow the drivers of vehicles to pay attention if the distance is short, or blinks the red light if the distance is somewhat long.

When a normal state is recovered through the clearance of the accident scene and then a manager brings the RF card 600 into contact with the post cap 30, the RF reception unit 470 of the post cap 30 receives a signal and sends the signal to the control unit 430, and the control unit 430 controls the light emission means 460 so that normal light emission can be performed.

What is claimed is:

1. A post cap for a guardrail equipped with light emission means capable of emitting light of various colors, comprising:
a Global Positioning System (GPS) reception unit for receiving GPS signals from satellites;
a storage unit for storing a program capable of controlling the light emission means based on a location of installation and time; and
a control unit for detecting the location of installation and time based on the GPS signals and the time input through the GPS reception unit, and controlling blink of the light emission means and color according to the program stored in the storage unit;
wherein the GPS signals are received, the location of installation and the time are detected based on the GPS signals, and variation in color is achieved based on the location of installation and the time according to the stored program, thereby enabling a plurality of adjacent post caps to operate with each other so as to emit light.

2. The post cap as set forth in claim 1, wherein the light emission means is provided with red, green and blue Light Emitting Diodes (LEDs), and represents various colors and patterns through combination of the LEDs.

3. The post cap as set forth in claim 1, further comprising a Radio Frequency (RF) reception unit for receiving Radio Frequency Identification (RFID) signals, and thus settings of the program stored in the storage unit can be changed in such a way that a manager brings an RFID chip, in which settings of the program are stored, into contact with the RF reception unit.

4. The post cap as set forth in claim 3, wherein the light emission means is provided with red, green and blue Light Emitting Diodes (LEDs), and represents various colors and patterns through combination of the LEDs.

5. The post cap as set forth in claim 1, wherein the post cap is connected to the adjacent post caps via a Ubiquitous Sensor Network (USN), monitors a surrounding situation, and enables a color and blinking state of the light emission means to be controlled in response to detection signals.

6. The post cap as set forth in claim 5, wherein a manager wirelessly sends settings of the program via the USN and then changes current settings of the program stored in the storage unit.

7. The post cap as set forth in claim 5, wherein the light emission means is provided with red, green and blue Light Emitting Diodes (LEDs), and represents various colors and patterns through combination of the LEDs.
